(19) United States
(12) Patent Application Publication
(10) Pub. No.: US 2002/0026445 A1
(43) Pub. Date: Feb. 28, 2002

(54) System and methods for the flexible usage of electronic content in heterogeneous distributed environments

(76) Inventors: Sebastian de la Chica, Longwood, FL (US); Alan J. McCutchen, Merritt Island, FL (US); Joseph E. Tilley III, Altamonte Springs, FL (US); Kelly J. Pritts, Oviedo, FL (US)

Correspondence Address: GREENBERG-TRAURIG, 1750 TYSONS BOULEVARD, 12TH FLOOR, MCLEAN, VA, 22102, US

(21) Appl. No.: 09/939,725

(22) Filed: Aug. 28, 2001

Related U.S. Application Data
(60) Provisional application No. 60/227,907, filed on Aug. 28, 2000.

(51) Int. Cl. G06F 7/00

(52) U.S. Cl. 707/100

(57) ABSTRACT

A system and methods supporting flexible content usage in distributed environments, where users may have access to electronic content from multiple disparate sources and rendering systems. The invention consists of a personal content management system and a collection of virtual information portfolios. The personal content management system manages user authentication, handles content uploads either from a public source such as a user or from an electronic content store, and transforms the content for specific rendering devices, thus providing ubiquitous access to said electronic content. The virtual information portfolio supports content distribution across multiple physical locations while providing support for multiple logical content groupings, including recursive content groupings. The virtual information portfolio allows logical content structure to be presented to users through a variety of formats, and enables the user to sell, share, lend, exchange, and trade digitally protected and non-protected electronic content directly with other users or entities.

This application claims priority from Provisional U.S. patent application Ser. No. 60/227,907, filed Aug. 28, 2000 by de la Chica, et al. which is hereby incorporated by reference in its entirety, and to Provisional U.S. patent application Ser. No. 60/276,950, filed Mar. 20, 2001 by de la Chica, et al, which is hereby incorporated by reference in its entirety. This application is also related to U.S. Patent Application entitled “System and Methods for the Production, Distribution, and Flexible Usage of Electronic Content in Heterogeneous Distributed Environments” filed by McCutchen, et al., concurrent with the filing of this application, the teachings of which is hereby incorporated in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to the field of flexible usage of electronic content or electronic data in heterogeneous distributed environments.

### BACKGROUND OF THE INVENTION

With the advent of advanced computer networking infrastructures such as the Internet and its successors, and the ever-increasing penetration of computers and computerized devices in everyday life, traditional manifestations of content—audio, visual, textual, and/or multimedia to name a few—continue to give way to higher quality electronic manifestations of said content. Electronic manifestations of content feature a series of innate properties that make them especially suitable for cheaper production, easier acquisition (including ownership transfers), and enhanced usage.

In addition to leveraging production pricing differentials brought about by faster, cheaper technology in the fields of central processing unit (CPU) speeds, data storage, and display devices, electronic manifestations of content facilitate searching and manipulation using well-known techniques in the areas of information indexing and electronic signal and symbol manipulation. Lower production costs for electronic manifestations of content have resulted in an increase in the volume of all forms of content available to end-users. In turn, increasing volumes of content have resulted in end-users being faced with a deluge of content that makes flexibility and ease of use key factors for the widespread adoption of electronic forms of content. This electronic content availability explosion has been accompanied by increasing concerns for the protection of the rights of the content creator or copyright owner (collectively “content creator”). The business and legal needs of protecting the rights of the copyright owner to these electronic manifestations of content is at odds with the mass distribution capabilities facilitated by advances in networking technology and applications.

Research and analysis of existing technology and inventions in the area of electronic content creation, acquisition, manipulation and usage show an increased focus in the following three areas: usage rights expression and enforcement, cryptographic techniques, and dedicated display devices. While the existing state-of-the-art in the aforementioned domains addresses important aspects of those domains, a vacuum exists in the areas that take advantage of the electronic medium to facilitate widespread adoption of electronic manifestations of content requiring secure delivery and controlled fair usage. In addition, existing technology and invention efforts fail to take into account the socio-economic factors accompanying the introduction of any new technology. As a result, the existing electronic content technologies and inventions tend to “get in the way” of content users accomplishing their goals, including attaining competitive advantages, informational enrichment, and entertainment.

In an information-driven environment, content users find it hard to tolerate the limitations brought about by inventions and products that hinder the content user's ability to locate, acquire, and use content in ways that protect the rights of the content owner while providing the content user with the flexibility previously afforded by earlier content technologies such as print books and magazines; music records, tapes and CDs; and movie DVDs. Current trends often force the end-user to tie the electronic content to a specific device, a tenet contrary to the uber-connectivity facilitated by advances in the communications and networking areas such as the Internet, wireless networks, and virtual private networks (VPNs).

Some inventions and commercial products exist in the usage rights technology arena that provide coverage in the areas of electronic content usage rights expression and enforcement of said rights descriptions. For example, U.S. Pat. No. 5,715,403, to Stefik, incorporated herein by reference, defines a limited grammar that allows the rights owner to describe a limited set of usage rights, and protocols that allows an entity to request and exercise any approved usage right defined at production time by the rights owner. The proposed limited usage rights grammar focuses on computer-centric atomic operations such as electronic content viewing, copying, and embedding while making no provision for the premise that the content rights owner and end-user may be interested in defining more flexible usage models that go beyond binary responses to requests for simple actions on the electronic content for a particular device.

Other prior art also attempts to address some of the shortcomings in content usage rights control through various schemes. For example, U.S. Pat. No. 5,845,281, to Benson, et al., which is incorporated herein by reference, addresses issues associated with enforcing usage rights via a computer program that checks content usage control data against content usage requests by an end user, and either grants or denies such access requests. In addition, U.S. Pat. No. 6,182,218, to Saito, incorporated herein by reference, presents both invisible and visible digital watermarking techniques for tracking electronic content usage through the use of a digital content management program embedded in the user's system.

While the aforementioned copyright protection techniques may prove useful in simple circumstances, these inventions do not address issues brought about by the fact that most end-users own a variety of rendering devices and systems. In addition, grammars proposed in the prior art fail to address a user's desire to engage in independent electronic content trading and exchange. This is an important oversight, as such trading and exchange may take place after a user has legally acquired a protected electronic content item.

Moreover, such inventions fail to recognize the need to provide content usage boundaries that adequately reflect and account for the environment surrounding content users where flexibility and ease of use are prime objectives. In other words, the state of the art fails to strike a balance between the content creator's copyright and piracy protection desires and the content user's yearning for flexibility and ease of electronic content use across multiple rendering devices and systems.

The field of cryptography finds its roots in ancient practices aimed to disguise, protect and securely transfer personal, political and military messages. Kahn provides in depth non-technical coverage of the history of cryptography from Ancient Times until the date of writing (1963) in his book The Codebreakers, which is incorporated herein by reference. Additional in-depth technical descriptions can be obtained from reading the Handbook of Applied Cryptography by Menezes, et al, incorporated herein by reference. In recent years, advances in the field of public-key cryptography have given rise to the publication of standard system definitions, such as the Public Key Infrastructure (PKI), which aim to formally describe usage of advanced cryptographic techniques initially described by Diffie and Hellman in their article “New directions in cryptography” in IEEE Transactions on Information Theory 22 (1976), the teachings of which are incorporated herein by reference. U.S. Pat. No. 6,098,056, to Rusnar and Zeintara, describes a three-level PKI-based approach solution for the cryptographic problem of trusted delivery of electronic content and its decryption. U.S. Pat. No. 6,226,618, Downs et al., provides a variation of the three-level PKI-based electronic content decryption key transfer where the intermediary is a “trusted” clearinghouse. U.S. Pat. No. 6,237,786, Van Wie and Weber, describes techniques that allow the invisible and indelible transfer of electronic rights management control information within a signal being transferred via an insecure channel. The teachings of the aforementioned patents are included herein by reference.

As illustrated by the aforementioned cryptography-related patents and references, current state of the art focuses on improved methods for content encryption and decryption key transfer while largely ignoring many of the issues associated with the practical usage of the electronic content once securely delivered to the end user.

New advances in electronics and electronic components have provided an environment where new inventions and products are conceived either as dedicated or multi-purpose electronic content rendering devices, including music devices and electronic book devices. U.S. Pat. No. 5,636,276, to Brugger, proposes a device for the secure, encrypted distribution of music in electronic form. U.S. Pat. No. 5,956,034, to Sachs and Pomeroy, describes a device capable of providing secure rendering of electronic books using encryption and in-memory decryption techniques. In both cases, the inventions focus mainly on generic protection of the electronic content while in transit as well as during aural or graphical rendering. Also importantly, the aforementioned patents serve to also exemplify the increasing number of content and rendering options available to users. The aforementioned patents are incorporated herein by reference.

As seen from the provided references, the current state of the art fails to address issues associated with providing users with an experience that is both pleasant and consistent with legally and socially acceptable fair content uses. It is particularly significant to note that none of the aforementioned inventions and products makes any provisions for supporting the availability of multiple content rendering systems and autonomous electronic content markets to the user. Similarly, provisions and mechanisms have not been developed which provide a user with ubiquitous access to electronic content. Such access would enable a user to experience content independent of their physical location or target rendering system.

For the purposes of describing the invention, the term “rendering system” refers to any combination of hardware and software components used to play back the electronic content visually, aurally, or by any other sensorial means. The separation of content from content rendering systems is important since it more closely describes commonly accepted practices such as playing a music Compact Disc (CD) using a CD player inside a vehicle and later playing the same music CD in a player located inside a house. In addition, the term “autonomous electronic content markets” and “autonomous electronic markets” refer to any combination of hardware and software components used to support legal, user-defined electronic content trade and exchange transactions.

### SUMMARY OF THE INVENTION

Accordingly, the present invention is directed to systems and methods for flexible electronic content usage in heterogeneous distributed environments that substantially obviates one or more of the problems due to limitations and disadvantages of the related art.

An object of the present invention is to allow extensible personal content management in a distributed heterogeneous environment.

Another object of the present invention is a system and methods to organize electronic content under personal content management system control into a virtual information portfolio containing one or more logical content groups, wherein a content group may recursively contain zero or more logical content groups.

An additional object of the present invention is an extension of the personal content management system to encompass both unprotected and protected electronic content. The personal content management system can also be further extended to process unprotected and protected content uploads, as well as electronic order confirmations for protected or unprotected content which originate from disparate electronic content distribution systems.

A further object of the present invention is to enable users to access personal content management systems from any access point within a distributed networked environment, utilizing tethered or wireless network access means.

Another object of the present invention is to allow users to fully or partially transfer selected electronic content items currently under personal content management system control to a distributed computing device for rendering and usage while in either network-connected or stand-alone modes.

An additional object of the invention is to extend the personal content management system to adaptively transform electronic content to match target rendering system capabilities.

Still another object of the invention is to provide a flexible, autonomous content market that also provides consistent and reliable copyright enforcement. The present invention provides such a content market through a system and methods by which individual electronic content items can be designated as available to either the general public or selected communities. Furthermore, users may designate individual content items as transferable, thereby indicating the content owner's desire to transfer electronic content ownership to a third-party, either temporarily or permanently. In addition, such ownership transfers may involve financial transfers between users or entities, including the involvement of an intermediary.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The present invention can be seen as extending and enhancing the prior art in the fields of electronic content usage rights enforcement and electronic content rendering device definition systems. In addition, the present invention provides methods supporting fair and flexible electronic content usage in distributed network environments. The present invention provides those improvements through systems and methods that enable users to manage and use disparate content in a distributed network environment by using a personal content management system.

Through a collection of hardware and software components, a personal content management system can track content attributes, such as content location, thereby allowing a user to access and control content stored in disparate locations through a consistent, easy to use interface. The personal content management system can also give users a virtual information portfolio, through which user owned content can be managed and organized. A virtual information portfolio may consist of a combination of hardware and software components which provide users with distributed virtual electronic content repositories. A virtual information portfolio provides users with a variety of electronic content presentations by transparently handling physical electronic content access. A virtual information portfolio provides both automatic and manual content grouping methods. Logical content groups may in turn contain zero or more internal content groups as designated by the user.

In a preferred embodiment, such content groups may be presented to a user through a tree-like graphical representation. In such a visualization scenario, intermediate nodes in a tree may represent logical groups, and terminal leaves in a tree can represent actual individual content available for upload, download, transformation, playback, exchange, trading and other operations. The preceding preferred embodiment description is intended to be exemplary, and should not be interpreted as limiting the scope of the present invention.

Since the virtual information portfolio may contain private information, the present invention also provides systems and methods to support user authentication. In a preferred embodiment, users are uniquely identified through PKI certificates. Authenticity of such certificates may be verified using a variety of methods, including, but not limited to, traditional authentication methods, like usernames and passwords, as well as more sophisticated authentication means, such as biometric identification techniques. While PKI provides established techniques to accomplish such authentication, the preceding description of a preferred embodiment is included here as exemplary and should not be considered as limiting the scope of the present invention to solely a PKI based approach.

The personal content management system leverages a template, or plug-in, architecture to provide an extensible mechanism capable of handling idiosyncrasies associated with specific electronic content upload, download, protection, and rendering systems. Furthermore, the virtual information portfolio provides mechanisms that enable a user to consistently manage protected and unprotected electronic content from a variety of sources. A virtual information portfolio provides access to content metadata that, in a preferred embodiment, can be used to describe and represent content owned by a user. For the purpose of describing the present invention, the term metadata refers to ancillary information about an electronic content item, and may include author, title, publication date, publisher name, and other information. The preceding list of metadata components should be considered as exemplary and by no means comprehensive or limiting the scope of the present invention.

The personal content management system also provides programmatic mechanisms necessary to enable access to virtual information portfolio contents, including actual content. The personal content management system can also contain ancillary content information collected from distributed computing devices, rendering systems, and the files connected to a distributed communications network, including information collected using a variety of protocols. The present invention facilitates transparent software component transfers to target rendering systems by handling user authentication, electronic content transfer, transformation, rendering, copyright protection, and other services.

The present invention also allows a user to define, manage, and operate an autonomous electronic content marketplace. This aspect of the invention leverages innate content characteristics to facilitate low overhead content ownership transactions. A personal content management system can also provide systems and methods to define external user access policies to content within a virtual information portfolio. Much as users trade, barter, and borrow current physical media, such as books, CDs and DVDs, the present invention allows users to define policies and constraints surrounding such trading practices for their electronic content. This aspect of the invention is of particular significance for secure electronic content that requires a fine degree of sensitivity to the issues associated with copyright protection. While the present invention facilitates the trading of legally owned electronic content manifestations, the system also provides mechanisms to enable copyright protection.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a distributed network where a user may access said network from a number of disparate access points and where electronic content manifestations may reside on different physical locations across said network.

FIG. 2 is a block diagram showing a logical view of a virtual information portfolio, including several logical content groupings.

FIG. 3 is a block diagram depicting an information flow that may be used for authentication purposes in a preferred embodiment to control access to a virtual information portfolio.

FIG. 4 is a block diagram illustrating interactions among system components facilities content acquisition, delivery, and rendering.

FIG. 5 is a Unified Modeling Language (UML) sequence diagram depicting a control flow enabling a user to access content requiring secure rendering using a remote wireless device.

FIG. 6 is a block diagram illustrating a structure which supports a virtual information portfolio's ability to manage and trade electronic content.

### DETAILED DESCRIPTION OF THE PREFERRED EMBODIMENT

Reference will now be made in detail to preferred embodiments of the present invention, examples of which are illustrated in the accompanying drawings.

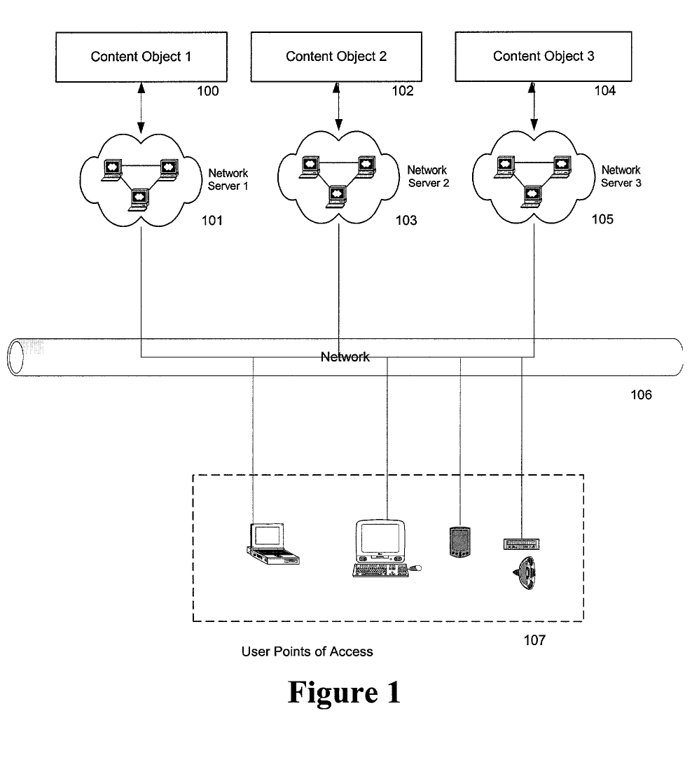

FIG. 1 addresses two important objects of the present invention: content location and user access. FIG. 1 presents collections of electronic content 100, 102, and 104, which, for the purposed of the embodiment illustrated in FIG. 1, are assumed to be owned by a single user. The present invention allows content 100, 102, and 104, to reside at completely separate physical locations, represented in FIG. 1 by network servers 101, 103, and 105. In a preferred embodiment, network servers 101, 103, and 105 can be interconnected via a common network backbone 106. It should be apparent to one skilled in the art that alternative embodiments, including those in which network servers 101, 103, and 105 are physically connected to independent networks, are also possible and within the scope and spirit of the present invention. From a user's perspective, the present invention provides seamless access to content 100, 102, and 104 through a variety of access points 107, which may include desktop computers, laptops, wireless computing devices, wireless communication devices, and other devices.

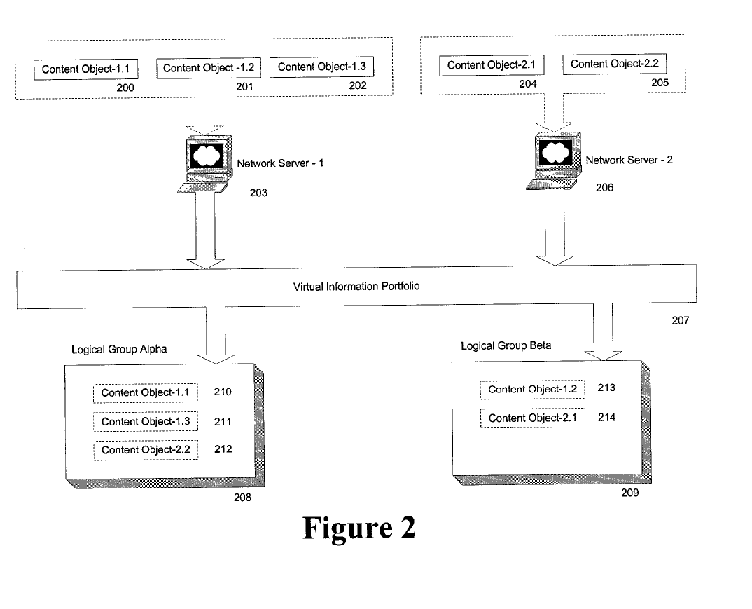

FIG. 2 presents a logical view of content location aspects of the present invention. FIG. 2 illustrates the use of a virtual information portfolio 207 to insulate users from the details of the physical layout of electronic content objects 200, 201, 202, 204, and 205. In FIG. 2, content objects 200, 201, and 202 are shown to physically reside in network server 203, while electronic content objects 204 and 205 are shown to reside in network server 206. For the purposes of describing this aspect of the invention, one can assume that the aforementioned content objects legally belong to a single user.

Virtual information portfolio 207 is multi-layer software arranged in a multi-tier architecture. A presentation application layer on a user device (not illustrated) and provides an interface to data stored in, and services provided by, virtual information portfolio 207. In the business logic tier, virtual information portfolio 207 consists of an interface layer that tracks content attributes, including user defined attributes, and allows users to group content based on those attributes. In addition, virtual information portfolio 207 serves as a logical layer that provides a mapping between how users organize and perceive their electronic content for their own purposes and where content objects physically reside within a network.

FIG. 2 illustrates a user who has organized electronic content into two logical content groups, 208 and 209 that contain different electronic content objects based on a user's preferred categorization scheme. For example, Logical Group Alpha 208 contains references to content objects 210, 211, and 212 that in actuality represent physical electronic objects stored in different locations across a network. While Content Object-1.1 210 and Content Object-1.3 211 are physically stored in Network Server-1 203, Content Object-2.2 212 is physically stored in Network Server-2 206.

In a preferred embodiment, virtual information portfolio 207 can allow a user to manually create, delete, modify, and manipulate logical content groups. In addition, a user may add and remove individual content items, and create recursive structures. In alternative embodiments, the present invention may include the complementary use of electronic content indexing and classification systems and methods to aid in the automated organization of large volumes of content.

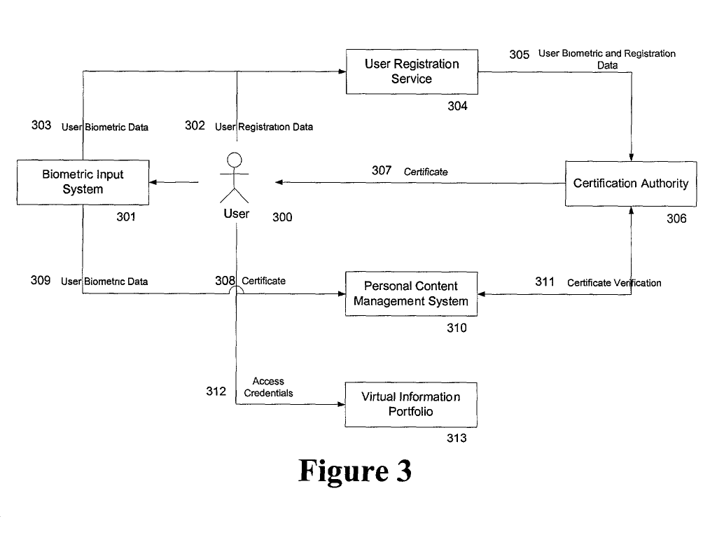

FIG. 3 illustrates a preferred embodiment in which biometric input system 301 and standard PKI techniques provide user 300 with authenticated access to the contents of virtual information portfolio 313 in a preferred embodiment. Before user 300 is granted access to virtual information portfolio 313, user 300 performs a one-time registration step with registration service 305. As part of this process, user 300 provides user registration data 302, along with user biometric data 303, to registration service 304. User registration data 302 may include, but is not limited to, different degrees of demographic information about user 300. User biometric data 303 is collected and transferred to registration service 304 through biometric input system 301.

For the purpose of describing the present invention, biometric input system 301 may consist of a collection of hardware and software components capable of collecting, encoding, and communicating one or more biological metrics taken from user 300 with the user's consent. Such biometric measurements may vary in degrees of uniqueness and physical intrusiveness and may include fingerprinting, retinal scans, DNA sampling, and the like. Since both biometric and demographic data present significant privacy issues, the present invention may be extended by one skilled in the art to employ standard PKI asymmetric encryption techniques to securely exchange registration information 302 and 303 with registration service 304. Registration service 304 communicates registration data 305 to PKI certification authority 306, which encodes registration data 305 into PKI certificate 307 and delivers it to user 300.

When user 300 requests access to virtual information portfolio 313, personal content management system 310 allows user 300 to send PKI certificate 308 and user biometric data 309 for verification. Once personal content management system 310 has verified biometric information encoded in certificate 308 with the provided user biometric data 309, user 300 may be granted access to virtual information portfolio 313. While not explicitly depicted in FIG. 3, user 300 may control multiple virtual information portfolios through a single personal content management system, or may use multiple personal content management systems to mediate access to multiple virtual information portfolios. While the preceding description focuses on specific concepts associated with standard PKI and biometric identification techniques, it should be apparent to one skilled in the art that alternative approaches may be considered to address security and authentication issues without departing from the spirit or scope of the invention.

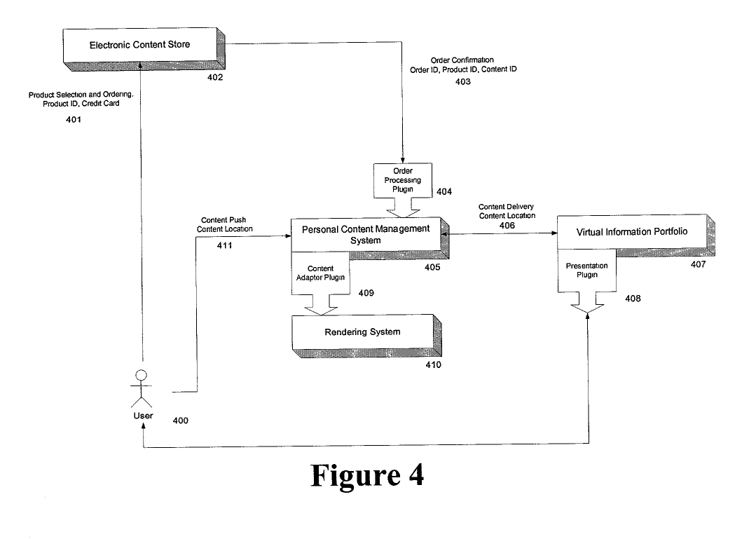

FIG. 4 illustrates activities and control flow associated with electronic content acquisition, management, and rendering. The present invention encompasses said activities for both protected and unprotected content. FIG. 4 illustrates two distinct logical flows.

With respect to unprotected content, user 400 may directly initiate content upload or transfer 411 to virtual information portfolio 407. In such a scenario, personal content manager 405 can transfer data 406, which can include content information, such as the physical location of the content, and optionally the content itself, to virtual information portfolio 407.

In the protected content scenario depicted in FIG. 4, user 400 can interact with electronic content store 402 via programmatic or interactive means to browse and select protected content for purchase. Once user 400 decides which electronic content manifestation to purchase, information about the product 401, such as a product identifier and payment information, to electronic content store 402. Once payment information has been cleared by electronic content store 402, electronic content store 402 may transfer electronic order confirmation 403 to personal content management system 405. In a preferred embodiment, order confirmation 403 may contain an order identifier, a content identifier, and a product identifier. Such identifiers can allow personal content management system 405 to obtain content information 406 required by virtual information portfolio 407 to facilitate content rendering and presentation of said content to user 400. Personal content management system 405 is capable of processing electronic order confirmations 403 from multiple electronic content stores 402 through order processing plug-ins 404 customized for individual order confirmation protocols.

Personal content management system 405 handles communications with virtual information portfolio 407, which in turn is responsible for handling storage and content presentation. Content presentation can be handled through a series of presentation plugins 408 that may present content to user 400 using a variety of textual presentations, graphical metaphors, or other sensorial presentations. In addition, personal content management system 405 can transform and transfer content to external rendering device 410 using content adaptor plug-ins 409. Such content adaptor plug-ins 409 may interact with external rendering device 410 to determine its rendering capabilities, and use information contained in ancillary content objects to transform the content for subsequent rendering in external rendering device 410.

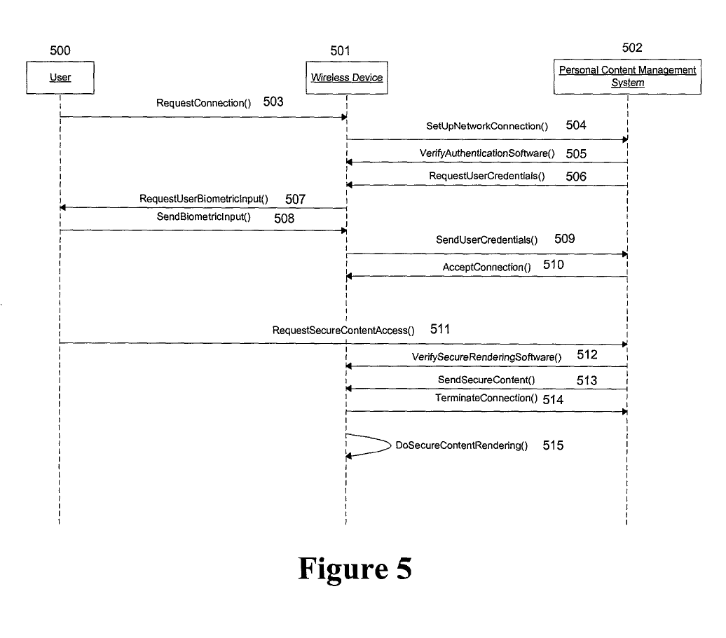

FIG. 5 illustrates a preferred message sequence as exchanged between user 500, wireless device 501, owned by user 500, and personal content management system 502, for the purposes of giving wireless device 501 access to specific content. User 500 can initiate the exchange by requesting a connection 503 via wireless device 501. Wireless device 501 responds to said request by setting up a network connection 504 to personal content management system 502. At that point, personal content management system 502 interacts with wireless device 501 to determine whether or not said device features necessary and up-to-date authentication software 505 required for authentication. If target wireless device 501 does not have necessary authentication software installed, or if an authentication software component is out of date, an up-to-date authentication software component can be distributed to said wireless device 501 for installation.

Once any necessary authentication software has been verified as installed in target wireless device 501, an authentication sequence can be initiated by personal content management system 502 requesting user credentials 506 from wireless device 501. At this stage, wireless device 501 requests biometric user input 507 from user 500, which is to be used as part of data to be sent to personal content management system 502 for authentication purposes. User 500 provides requested biometric user input 508, which is forwarded 509 by wireless device 501 to personal content management system 502. If the user certificate matches the biometric data sent by wireless device 501, personal content management system 502 may accept connection 510, thus allowing user 500 to access the virtual information portfolio contents.

Once authenticated, user 500 can request access to content 511 that requires secure rendering for copyright protection reasons. Personal content management system 502 may communicate with wireless device 501 to verify 512 that software required to produce a secure content rendering is already installed on the target wireless device 501. If the necessary software is not installed, or if said secure rendering software is out of date, personal content management system 502 may initiate installation of the required software. Once wireless device 501 has the necessary secure rendering software installed, personal content management system 502 can transform and transfer 513 content to target wireless device 501.

In a preferred embodiment, personal content management system 502 can transfer content 513 to target wireless device 501, thereby allowing user 500 to disconnect from network 514 after said data transfer is complete, thus minimizing carrier charges for metered wireless network usage. Alternative embodiments may utilize electronic data streaming techniques to transfer electronic content, as needed, to target wireless device 502 for secure rendering in situations where network access costs are not an issue. Once wireless device 501 receives the content, connections with personal content management system 502 can be terminated 514. From that point on, user 500 may access content directly from wireless device 501, and may produce a secure rendering 515 that does not require further authentication or network connectivity.

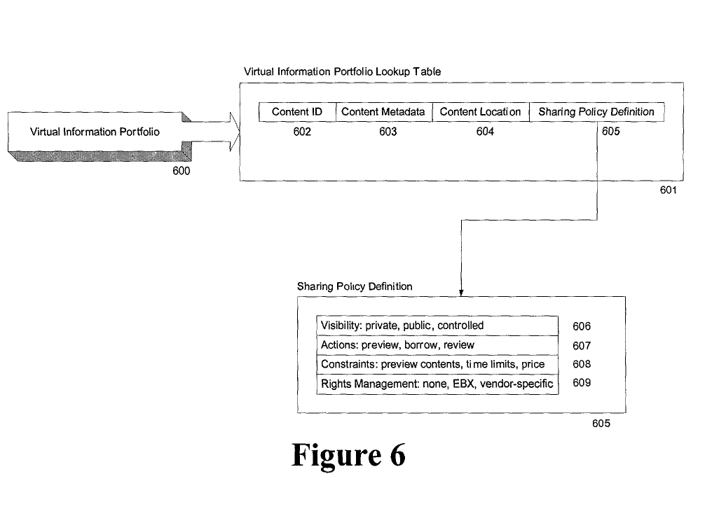

FIG. 6 illustrates data structures that may be used in a preferred embodiment to support the ability of a virtual information portfolio 600 to create an autonomous electronic content marketplace. Virtual information portfolio 600 maintains an internal look-up table 601 to keep track the information necessary to present the contents of virtual information portfolio 600 to a user, and to locate the actual electronic content data. In a preferred embodiment, look-up table 601 keeps all entries indexed by unique content identifier 602. Such a content identifier 602 may follow existing content identification schemes, such as International Standard Book Number (ISBN) or Digital Object Identifier (DOI), or it may employ an entirely new, unique content identification and numbering scheme. Look-up table 601 may also contain content metadata 602, content location 603, and sharing policy definition 604. It should be apparent to one skilled in the art that the number of fields may be increased or decreased, and that additional fields can be substituted for those set forth above, without departing from the spirit or scope of the invention.

Content metadata 602 may contain a varying number of data fields that describe the electronic content manifestation in further detail, including, but not limited to, title, author, publication data, and publisher. Content location 603 provides an unambiguous description of the physical content location. For content location 602 expression purposes, look-up table 601 may use a standard resource locator specification, such as a Uniform Resource Locator (URL), or similar scheme. Sharing policy definition 603 provides a user with the flexibility to control how electronic content manifestations may be presented to outside users and programmatic entities.

Through sharing policy definition 603, the present invention extends a user's ability to trade electronic content outside the context of pre-established electronic commerce infrastructures, and allows a user to exploit the competitive and financial advantages of a more flexible, autonomous content market. Sharing policy definition 603 centers around four main areas: content visibility 606, content actions 607, content actions constraints 608, and rights management 609.

Content visibility 606 allows a user to define whether particular content is private, public, or controlled. Private content may be visible to only authenticated users who have previously registered with a registration service, while public content may be visible to any user who may or may not have previously registered with said registration service. Controlled content refers to electronic content manifestations that are visible to certain authenticated users of other personal content management systems within the network. Through a distributed registration service, authenticated users may be organized into groups that facilitate specification of access control policies for controlled electronic content. It is important to note that such user groupings may be associated with corporate organizational information stored in a Light-weight Directory Access Protocol (LDAP) service, or may be based on less structured organizational units such as freely associated network user communities. A goal of the invention is to allow users to define which external users have access to specific content within a virtual information portfolio.

Content actions 607 allow a user to specify which operations are allowed for a specific electronic content manifestation. Content actions 607 are only available to users who meet criteria specified in content visibility 606. In a preferred embodiment, virtual information portfolio 600 gives a user control over at least the following actions: content previewing, content borrowing and content review editing. It should be apparent that one skilled in the art could extend the range of supported virtual information portfolio operations and remain within the scope and spirit of the present invention.

For content previewing purposes, the constraint may specify which portions of the electronic content manifestation are available for preview. It is important to note that for secure content, the length and nature of the electronic content preview may be specified by the content creator at content creation time. For content borrowing purposes, the constraint may help a user place chronological and financial boundaries around such a transaction. For example, a user could specify a time limit of 48 hours and a price of five U.S. dollars for a particular content to allow for the checkout of that content for said price to an external user. In another example, a user could specify no time limit and a price of ten U.S. dollars for particular content to allow for the permanent sale of the content to external users. In essence, virtual information portfolio 600 may use look-up table 601 to support the emergence of independently owned and operated personal digital marketplaces supporting a variety of content usages and business models in a noncentralized fashion.

The present invention addresses issues of copyright protection in lookup-table 601 by providing a field within sharing policy definition 605 that tracks the digital rights management (DRM) requirements 609 particular content. In a preferred embodiment, this field may contain values indicating that the content does not require any copyright protection, or the identifier for the copyright protection scheme required by the electronic content. Such copyright protection scheme identifiers may point to industry standards, such as those defined by the Electronic Book Exchange (EBX), or vendor-specific techniques. It should be apparent to one skilled in the art that the example values described above may be extended with additional DRM techniques as they become generally accepted and available and should not be construed as limiting the scope of the present invention.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A content organization system comprising:
a user interface;
one or more content files;
a means of defining one or more content groups;
a means of assigning said content into one or more of said content groups; and
a means of tracking and storing user rights associated with said content files.

2. The content organization system of claim 1, in which said means of creating content groups allows a user to define custom content groups.

3. The content organization system of claim 1, in which said means of creating content groups automatically creates content groups based on content attributes and assigns said content file to the appropriate content groups.

4. The content organization system of claim 3, in which said content group association means is capable of receiving order confirmation information from a content distributor and automatically acquiring and categorizing content based on such order confirmation information.

5. The content organization system of claim 1, in which said one or more content files are distributed across a plurality of content storage systems.

6. The content organization system of claim 1, in which said content group association means allows said content groups to contain not only references to individual content, but also other content groups.

7. The content organization system of claim 1, in which said user interface uses one of a plurality of presentation adapters to display said content groups, said content attributes, and said content in a manner preferred by a user.

8. The content organization system of claim 7, in which said content group association means allows content groups containing other content groups to be arranged in a hierarchical fashion.

9. The content organization system of claim 1, further comprising a means for monitoring and controlling content based on rights granted to a user through digital rights management attributes associated with said content.

10. The content organization system of claim 9, further comprising:
a user identification and authentication means; and
an interface through which a user may selectively give one or more others varying rights to content stored within one or more of said content groups.

11. The content organization system of claim 10, in which said user identification and authentication means includes a biometric identifier and associated biometric equipment.

12. The content organization system of claim 10, in which said one or more others includes both unauthenticated and authenticated users.

13. The content organization system of claim 10, in which said content monitoring and controlling means also allows transferring of said digital rights management attributes to other users.

14. The content organization system of claim 13, in which said digital rights management attribute transfers include a time restriction, thereby allowing users to loan content to other users.

15. The content organization system of claim 14, in which said content monitoring and controlling means also provides for electronic commerce transactions.

16. An extensible content storage system comprising:
a content storage means;
one or more order processing templates, which translate received order confirmations into a standardized format that can be interpreted by the system; and
one or more content adaptor templates, which translate said content for display by a rendering device.

17. An extensible content storage method, comprising the steps of:
placing a content order with a content distributor;
receiving an order confirmation from said content distributor;
determining said order confirmation type;
translating said order confirmation into a standard format;
obtaining said ordered content from said content distributor;
obtaining available content attributes from said content distributor; and
storing said ordered content and said available content attributes in a content storage system.

18. The extensible content storage method of claim 17, in which said available content attributes include content rights information and content rules.

19. The extensible content storage method of claim 18, further comprising the steps of:
periodically reviewing said content rights information; and,
executing appropriate content rules based on said periodic reviews.

20. The extensible content storage method of claim 18, further comprising the steps of:
allowing a user to select content to be rendered and a content rendering device to perform such rendering;
determining content rendering device capabilities;
selecting a content adapter consistent with said content rules and said rendering device capabilities; and
adapting said selected content such that said rendering device is capable of rendering said selected content.

21. The extensible content storage method of claim 18, in which said content storage system distributes said content and content attributes across a plurality of storage devices.

22. An extensible content rendering method, comprising the steps of:
allowing a user to select content to be rendered;
allowing a user to select a rendering device to render said selected content;
determining rendering capabilities of said rendering device;
installing one or more additional rendering systems on said rendering device if said rendering device is not capable of adequately rendering said content;
polling said rendering device to determine content security capabilities of said rendering device;
installing one or more additional security systems on said rendering device if said rendering device is not capable of adequately securing said content while said content is stored on and rendered by said rendering device;
transmitting said content to said rendering device; and
rendering of said content by said rendering.

23. The content rendering method of claim 22, further comprising the steps of:
selecting a content adapter template from a plurality of available content adapter templates based on rendering systems available on said rendering device; and
transforming said content using said selected content adapter.

24. The content rendering method of claim 23, in which said content adapter template is further selected based on rules associated with said content.

25. The content rendering method of claim 23, in which said content is transformed into a format capable of most accurately reproducing said content on said rendering device.
